(19) United States
(12) Patent Application Publication
(10) Pub. No.: US 2014/0313422 A1
(43) Pub. Date: Oct. 23, 2014

(54) PROJECTION TYPE VIDEO DISPLAY

(71) Applicant: Mitsubishi Electric Corporation, Tokyo (JP)

(72) Inventors: Naoki KANNO, Tokyo (JP); Shigenori SHIBUE, Tokyo (JP)

(73) Assignee: Mitsubishi Electric Corporation, Tokyo (JP)

(21) Appl. No.: 14/097,044

(22) Filed: Dec. 4, 2013

(30) Foreign Application Priority Data
Apr. 17, 2013 (JP) 2013-086215

(51) Int. Cl. H04N 5/74

(52) U.S. Cl. CPC H04N 5/7416
USPC 348/744

(57) ABSTRACT

A projection type video display includes a light source controller and a light amount detection sensor. The light source controller controls currents so as to sequentially turn off a plurality of LEDs forming each of LED arrays, detects a change in output light amount before and after each of the plurality of LEDs turn off by the light amount detection sensor to detect an abnormal turning-on of each of the LEDs, and performs control so as to interrupt a current supply to the LED in which an abnormal turning-on has been detected.

### BACKGROUND OF THE INVENTION

1. Field of the Invention

The present invention relates to the control of turning-on of light sources in a projection type video display.

2. Description of the Background Art

One common projection type video display modulates and combines the illumination light beams emitted from light sources based on an image signal and projects them onto a screen, to thereby display video on the screen. Increasing demands for reduced size and consumption power of the display and for a longer light source life lead to widespread use of light emitting diodes (LEDs) in place of discharge lamps typically used as light sources.

For example, the projection type video display, which includes LEDs as light sources, combines the illumination light beams from light sources composed of three LEDs emitting light beams of respective three primary colors of red, green, and blue by means of a dichroic mirror, dichroic prism, or the like and then modulates the combined light beams into video light by an image display device such as a digital micromirror device (DMD), to thereby project color video.

The projection type video displays including LEDs as light sources range from a display including one LED as a light source to a display including an LED array formed of a plurality of arranged LEDs as light sources. The display including an LED array needs to control turning-on of individual LEDs forming the LED array.

As an example, Japanese Patent Application Laid-Open No. 2009-237483 discloses the display that alerts a user to the malfunctioning laser diode (LD) in the malfunctioning LD array. Japanese Patent Application Laid-Open No. 2009-169348 discloses the display that controls turning-on of a light source having poor light emitting efficiency in the light sources forming the light source array, thereby improving the light emitting efficiency for the fed power.

For projection type video displays including LED arrays each formed of, for example, six LEDs, the drive circuit could conceivably have the function of detecting turning-on of the LEDs. In many such cases, it is conceivable that six LEDs are connected with one drive circuit in consideration of the size and manufacturing cost of the circuit. In series connection of six LEDs with the drive circuit, the LEDs all turn off due to a failure of one LED, and thus, the six LEDs and the drive circuit are desirably connected in parallel.

A short-circuit failure occurring during parallel connection can be easily detected using a voltage applied to a voltage detection resistor connected in series with the LEDs. The current limiting circuit connected to the LEDs allows them to continue operating during a short-circuit failure without further damaging themselves.

Meanwhile, when a current fails to flow due to an open circuit failure of one LED in parallel connection, the currents to be applied to the other LEDs increase. Each of the LEDs forming the LED array needs a current detection circuit for detecting an open circuit failure in parallel connection, increasing a circuit size, which also increases a manufacturing cost.

The display, which is described in Japanese Patent Application Laid-Open No. 2009-237483, merely alerts a user to the laser diode (LD) malfunctioning in the malfunctioning LD array and does not take turning-on control into consideration. The display, which is described in Japanese Patent Application Laid-Open No. 2009-169348, improves the light emitting efficiency for the fed power through turning-on control of a light source having poor light emitting efficiency in light sources forming the light source arrays, but does not detect a failure.

### SUMMARY OF THE INVENTION

The present invention has an object to provide a projection type video display, which includes no failure detecting circuit, capable of detecting a turn-on state of a plurality of light sources forming a light source array, to thereby control turning-on based on the detected turn-on state of the light sources.

A projection type video display according to the present invention modulates, in response to a video signal, the light emitted from a plurality of light source arrays into video light to project the video light, each of the light source arrays including a plurality of light sources. The projection type video display includes a controller that performs control on the plurality of light sources, such as control of currents to be supplied to the plurality of light sources forming the light source arrays, and a light amount detection sensor that detects an output light amount from each of the light source arrays. The controller controls the currents so as to sequentially turn off the plurality of light sources forming each of the light source arrays, detects a change in output light amount before and after turning off of each of the plurality of light sources by the light amount detection sensor to detect an abnormal turning-on of each of the light sources, and performs control so as to interrupt a current supply to the light source in which the abnormal turning-on has been detected.

Another projection type video display according to the present invention modulates, in response to a video signal, the light emitted from a plurality of light source arrays into video light to project the video light, each of the light source arrays including a plurality of light sources. The projection type video display includes a controller that performs control on the plurality of light sources, such as control of currents to be supplied to the plurality of light sources forming the light source arrays, and a light amount detection sensor that detects an output light amount from each of the light source arrays. Upon detection of a reduction in output light amount by the light amount detection sensor, the controller controls the currents such that the plurality of light sources forming the light source array in which a reduction in output light amount has been detected sequentially turn off, detects a change in output light amount before and after turning off of each of the plurality of light sources by the light amount detection sensor to detect an abnormal turning-on of each of the light sources, and performs control so as to interrupt a current supply to the light source in which an abnormal turning-on has been detected.

According to the present invention, the controller controls the currents so as to sequentially turn off a plurality of light sources forming each of the light source arrays, detects a change in output light amount before and after turning off of the plurality of light sources by the light amount detection sensor to detect an abnormal turning-on of each light source, and performs control so as to interrupt a current supply to the light source in which an abnormal turning-on has been detected.

Thus, the turn-on state of a plurality of light sources forming the light source array can be detected, which allows for turning-on control based on the detected turn-on state of the light sources. Besides, the use of the light amount detection sensor, which is typically mounted for brightness correction, eliminates the need for newly providing a failure detection circuit.

These and other objects, features, aspects, and advantages of the present invention will become more apparent from the following detailed description of the present invention when taken in conjunction with the accompanying drawings.

### BRIEF DESCRIPTION OF THE DRAWINGS

FIG. 1 is a configuration diagram of a projection type video display according to a first preferred embodiment;

FIG. 2 is an arrangement diagram of an LED array;

FIG. 3 is a connection diagram of the LED array and an LED drive circuit;

FIG. 4 is a flowchart of the operation of detecting an abnormal turning-on of the LED array; and

FIG. 5 is a flowchart of the operation of detecting an abnormal turning-on of an LED array in a projection type video display according to a second preferred embodiment.

### DESCRIPTION OF THE PREFERRED EMBODIMENTS

### First Preferred Embodiment

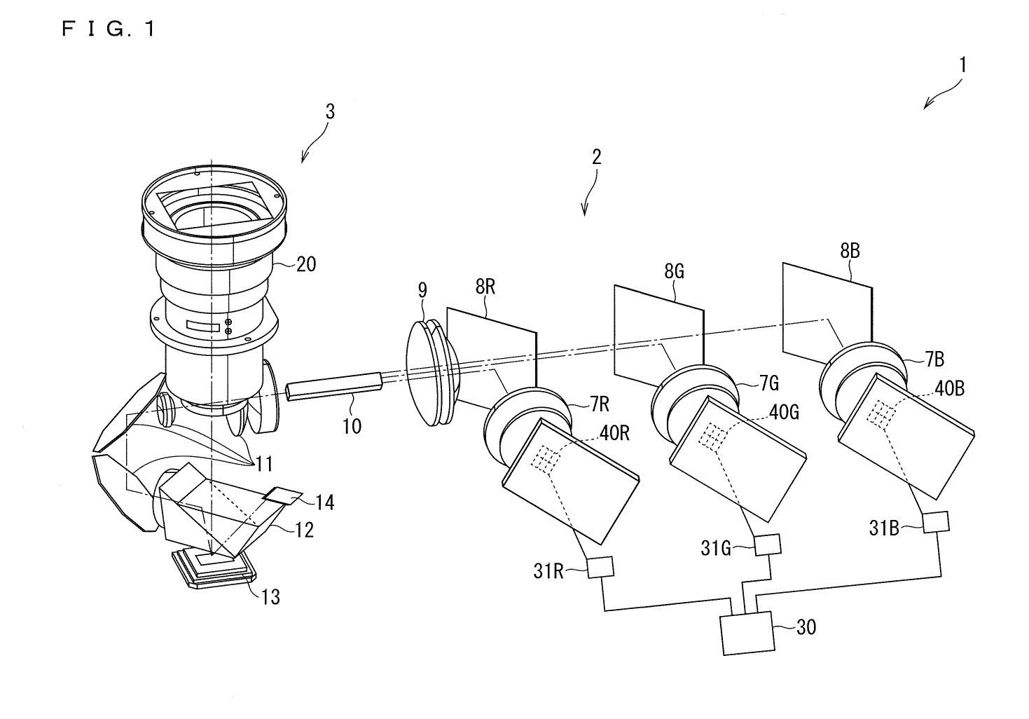

A first preferred embodiment of the present invention is described below with reference to the drawings. FIG. 1 is a configuration diagram of a projection type video display 1 according to the first preferred embodiment. As shown in FIG. 1, the projection type video display 1 is broadly divided into an illumination optical system 2 including light sources, a light source controller 30 (controller), and a projection optical system 3 that changes the illumination light emitted from the illumination optical system 2 into video information and projects the video information onto a screen (not shown).

The illumination optical system 2 includes a red LED array 40R, a green LED array 40G, and a blue LED array 40B that are light source arrays, collimator lens groups 7R, 7G, and 7B, dichroic mirrors 8R, 8G, and 8B, a condensing lens group 9, and LED drive circuits 31R, 31G, and 31B. The LED arrays 40R, 40G, and 40B are each formed of, for example, six LEDs (more generally, m LEDs, where m is an integer equal to or larger than two) as light sources.

The LED drive circuits 31R, 31G, and 31B drive the LED arrays 40R, 40G, and 40B, respectively, through control by the light source controller 30. The LED drive circuits 31R, 31G, and 31B, which are constant current circuits, are controlled so as to obtain a constant total of the current consumption of the LED arrays 40R, 40G, and 40B, respectively. The current value obtained is always the same irrespective of the number of LEDs turning on in the LED arrays 40R, 40G, and 40B. For example, in a case where the LED drive circuit 31R supplies a current of 12A, a current of 2A flows through each LED during turning-on of six LEDs in the LED array 40R, and a current of 2.4 A flows through each LED during turning-on of five LEDs.

The collimator lens groups 7R, 7G, and 7B shape the illumination light beams of three primary colors of red, green, and blue, which are sequentially emitted from the LED arrays 40R, 40G, and 40B, respectively, to be substantially parallel. The dichroic mirrors 8R, 8G, and 8B each select the illumination light beams (a ray of light) shaped to be substantially parallel and cause the selected illumination light beams to be reflected thereon or pass therethrough, to thereby combine those illumination light beams into one optical path. The condensing lens group 9 condenses the illumination light beams each composed into one optical path and emits those to the projection optical system 3.

The light source controller 30 controls a plurality of LEDs forming the LED arrays 40R, 40G, and 40B, such as control of the currents to be supplied to the plurality of LEDs. More specifically, the light source controller 30 controls the currents to be supplied to the plurality of LEDs of the LED arrays 40R, 40G, and 40B through control of the LED drive circuits 31R, 31G, and 31B, to thereby control turning-on of the LED arrays 40R, 40G, and 40B, respectively. The light source controller 30 detects a change in output light amount of the LEDs, which is described below.

The projection optical system 3 includes an integration device 10, a relay lens group 11, a total internal reflection (TIR) prism 12 having a total reflection surface therein, a DMD (image display device) 13, a light amount detection sensor 14, and a projection lens 20.

The integration device 10, which is usually a light tunnel or glass rod, uniformizes the illuminance distribution of the illumination light beams emitted from the condensing lens group 9 and emits the resultant to the relay lens group 11. The relay lens group 11, which is formed of lenses and reflecting mirrors, propagates the combined light of red, green, and blue emitted from the integration device 10 to the DMD 13 through the TIR prism 12.

The DMD 13 modulates the illumination light emitted from the integration device 10 through the relay lens group 11 and the TIR prism 12 into video light and emits the video light to the projection lens 20. The projection lens 20 projects the video light emitted from the DMD 13 toward the screen.

The light amount detection sensor 14, which is typically provided in the projection type video display for brightness correction, is radiated with one or more pulses of light per color for one frame of video signal, to thereby detect an output light amount. As one exemplary method, the light unused for video light in one frame is used as the light for irradiating the light amount detection sensor 14.

The LED arrays 40R, 40G, and 40B emit light sequentially, and thus, the light amount detection sensor 14 can detect an output light amount of each of the red, green, and blue colors. The light amount information of the LED arrays 40R, 40G, and 40B detected by the light amount detection sensor 14 is transmitted to the light source controller 30.

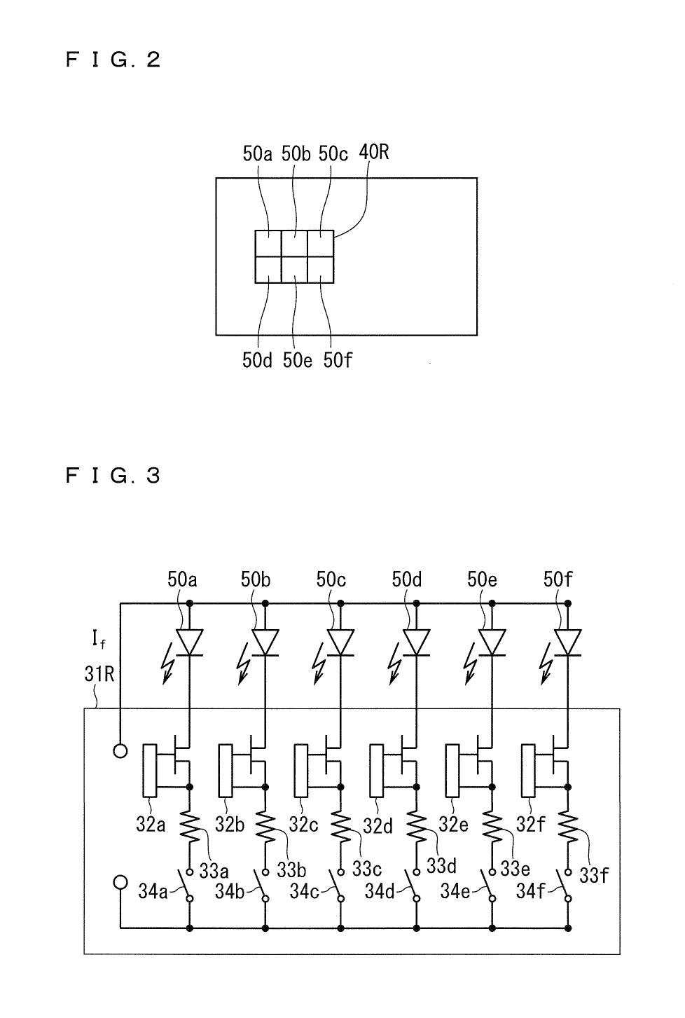

Next, the detection of an abnormal turning-on of the LED arrays 40R, 40G, and 40B is described with reference to FIGS. 2 and 3. FIG. 2 is an arrangement diagram of the LED array 40R, and FIG. 3 is a connection diagram of the LED array 40R and the LED drive circuit 31R. The LED arrays 40R, 40G, and 40B have the same configuration and the LED drive circuits 31R, 31G, and 31B also have the same configuration. Here, description is given using the LED array 40R and the LED drive circuit 31R.

The LED array 40R is formed of six LEDs 50a to 50f being a plurality of light sources, and the LEDs 50a to 50f are connected in parallel to one another. More specifically, the anodes of the LEDs 50a to 50f are connected to one another, and current limiting circuits 32a to 32f that limit a maximum current and voltage detection resistors 33a to 33f are connected to the cathodes of the LEDs 50a to 50f. The current limiting circuits 32a to 32f are connected to one-side ends of the voltage detection resistors 33a to 33f, respectively, and switches 34a to 34f for switching between turning on and off of the LEDs 50a to 50f are connected to the other-side ends of the voltage detection resistors 33a to 33f, respectively.

Upon change in the voltage applied to the voltage detection resistors 33a to 33f during a short-circuit failure of the LEDs 50a to 50f, the current limiting circuits 32a to 32f detect the malfunctioning LED and then limit the current for the malfunctioning LED. This prevents a situation in which a current intensively flows into the spot of the short-circuit failure in the LEDs 50a to 50f and accordingly the LEDs 50a to 50f are damaged.

The LEDs 50a to 50f are connected in parallel to one another, and thus, a short-circuit failure occurring in the LED 50a causes all the currents applied to the LEDs 50a to 50f to flow into the voltage detection resistor 33a, boosting the detection voltage. The detection voltage exceeding a threshold allows the current limiting circuit 32a to limit the value of the current applied to the voltage detection resistor 33a.

The light source controller 30 can independently control the LEDs 50a to 50f of the LED array 40R to turn on and off. The light source controller 30 has a storage area for storing the number of LEDs that are turned on among the LEDs 50a to 50f forming the LED array 40R.

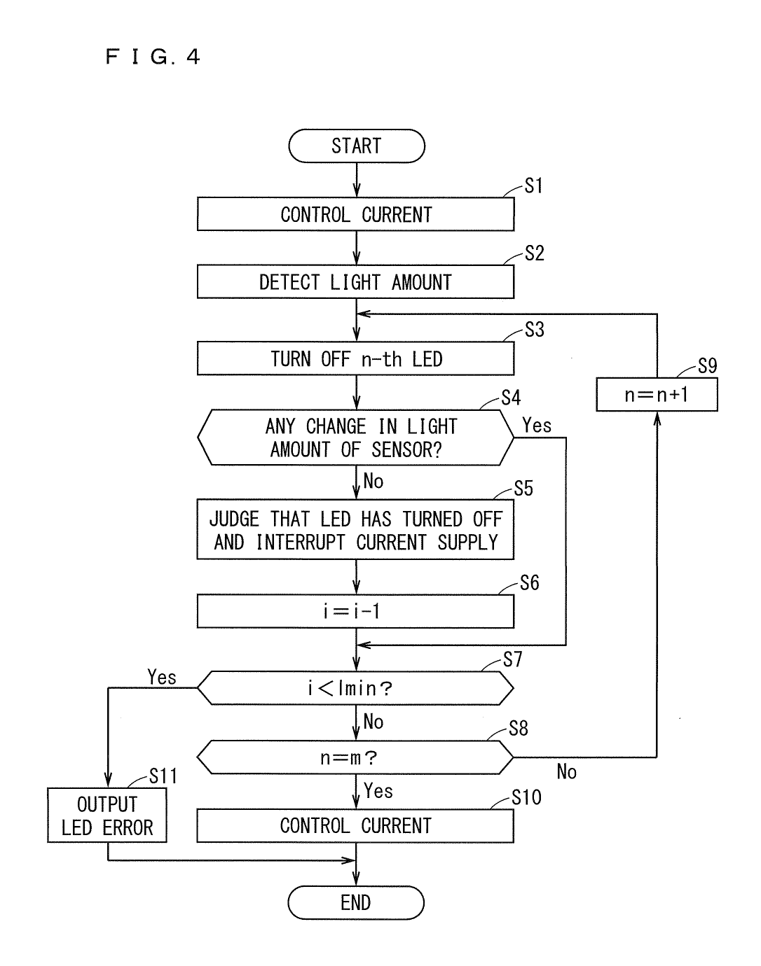

Next, the operation of detecting an abnormal turning-on of the LED arrays 40R, 40G, and 40B, which is performed by the light source controller 30, is described with reference to FIG. 4. FIG. 4 is a flowchart of the operation of detecting an abnormal turning-on of the LED arrays 40R, 40G, and 40B. The light source controller 30 regularly causes the LEDs 50a to 50f to turn off in the stated order, to thereby obtain the turn-on state of the LEDs 50a to 50f.

In the present embodiment, m=6 for the LED arrays 40R, 40G, and 40B, and numbers are assigned such that the LED 50a is the first, the LED 50b is the second, • • • and the LED 50f is the sixth. The light source controller 30 stores the number i (i is an integer equal to or smaller than m) of the LEDs that turn on per color. When all the LEDs turn on, i=m.

The LEDs 50a to 50f are connected in parallel as described above, so that if one of them turns off, a current is additionally applied to the other LEDs. When starting the operation of detecting an abnormal turning-on, the light source controller 30 controls an applied current If to the LED array of the target color (for example, red) to reduce by (i−1)/i times (Step S1) such that the currents to be applied to the individual LEDs become identical to those before starting the operation of detecting an abnormal turning-on.

Then, the light amount detection sensor 14 detects an output light amount at a current value adjusted in Step S1, and the light source controller 30 stores the value (Step S2). The light source controller 30 controls a current to turn off the n-th LED of the LED array of the target color (Step S3). In other words, the light source controller 30 controls the currents to be applied to the LEDs 50a to 50f to reduce immediately before controlling the currents so as to sequentially turn off the LEDs 50a to 50f. Here, n=1 in the initial state, and thus, the light source controller 30 performs the turning-off process to turn off the first LED.

The light source controller 30 judges the presence/absence of a change in output light amount using the light amount information of the light amount detection sensor 14 (Step S4). Here, the light source controller 30 judges (detects) a change in output light amount before and after the LED turns off, to thereby detect an abnormal turning-on of this LED. In a case of judging that the output light amount has changed before and after turning-off of the LED, that is, when judging that the output light amount after turning-off has reduced than the output light amount before turning-off (Yes in Step S4), the light source controller 30 judges that this LED has turned on before the turning-off process.

In this case, the light source controller 30 judges whether or not the number i of the turning-on LEDs falls below a minimum turning-on number 1 min (Step S7). If the number i of the turning-on LEDs does not fall below the minimum turning-on number 1 min (No in Step S7), the light source controller 30 judges whether n=m (Step S8). Here, n=1 and m=6, and thus, the light source controller 30 does not judge that n=m (No in Step S8), increments a count value of n by one (n+1) (Step S9) to turn off the next (n+1)th) LED, and then returns to Step S3.

In a case where no change is detected in output light amount, that is, when the output light amount before turning-off and the output light amount after turning-off are the same (No in Step S4), the light source controller 30 judges that the relevant LED has turned off before the turning-off process due to, for example, a failure, and then interrupts a current supply to this LED (Step S5).

Next, the value of the number i of turning-on LEDs is decremented by one (i−1) (Step S6). In this case, the light source controller 30 judges whether or not the number i of turning-on LEDs falls below the minimum turning-on number 1 min (Step S7). In a case where i falls below the minimum turning-on number 1 min (Yes in Step S7), the light source controller 30 outputs an LED error (Step S11), and then ends the operation of detecting an abnormal turning-on.

In a case where i does not fall below the minimum turning-on number 1 min (No in Step S7), the light source controller 30 executes Steps S8 and S9 to detect whether or not another LED is turning off, and then returns to Step S3.

The light source controller 30 repeats Steps S3 to S9 as many as the number of LEDs (m times), and then sets a current value such that If=If0×i/i0 (If0 is a current value before the operation of detecting an abnormal turning-on is started, and i0 is the number of LEDs turning on in start of the operation of detecting an abnormal turning-on) (Step S10).

In other words, in a case where an abnormal turning-on of the LED is not detected, the value of the current applied to the LED array is returned to the current value If0 before the operation of detecting an abnormal turning-on is started. In a case where an abnormal turning-on of the LED is detected, the light source controller 30 controls the current value If to be applied to the LED array to If0×i/i0 such that the value of the currents to be applied to the LEDs not malfunctioning is identical to the current value before the start of the operation of detecting an abnormal turning-on. A current supply to the malfunctioning LED is interrupted in Step S5.

The light source controller 30 ends the operation of detecting an abnormal turning-on of the red LED array and sequentially performs the operation of detecting an abnormal turning-on for the LED arrays of the other colors (such as green and blue). With reference to FIG. 3, the switches 34a to 34f are used for switching between turning on and off of the LEDs. Alternatively, switching means other than switches can be used.

As described above, in the projection type video display 1 according to the first preferred embodiment, the light source controller 30 controls currents so as to sequentially turn off a plurality of LEDs 50a to 50f forming the LED arrays 40R, 40G, and 40B, detects a change in output light amount before and after turning-off of each of the plurality of LEDs 50a to 50f by the light amount detection sensor 14 to detect an abnormal turning-on of each light source, and then performs control to interrupt a current supply to the light source in which an abnormal turning-on has been detected.

Thus, the turn-on state of a plurality of LEDs 50a to 50f forming the LED arrays 40R, 40G, and 40B can be detected to control turning-on based on the detected turn-on state of the LEDs 50a to 50f. This prevents a situation in which an overcurrent flows into the LEDs 50a to 50f and accordingly the LEDs 50a to 50f are damaged. The use of the light amount detection sensor 14, which is mounted typically for brightness correction, eliminates the need for newly providing a failure detection circuit.

The failure detection circuit becomes unnecessary, and thus, the circuit size can be reduced, allowing for miniaturization of the projection type video display 1.

One LED turns off among a plurality of LEDs 50a to 50f forming the LED arrays 40R, 40G, and 40B during the operation of detecting an abnormal turning-on, minimizing a reduction in video brightness during the operation of detecting an abnormal turning-on.

As described in Step S1 of the flowchart of FIG. 4, the light source controller 30 controls currents to be applied to a plurality of LEDs 50a to 50f to reduce immediately before the current is controlled such that the plurality of LEDs 50a to 50f sequentially turn off. This enables the light source controller 30 to first prevent a failure of an additional LED and then detect the turn-on state of the plurality of LEDs 50a to 50f forming the LED arrays 40R, 40G, and 40B, to thereby control turning-on based on the detected turn-on state of the LEDs 50a to 50f.

### Second Preferred Embodiment

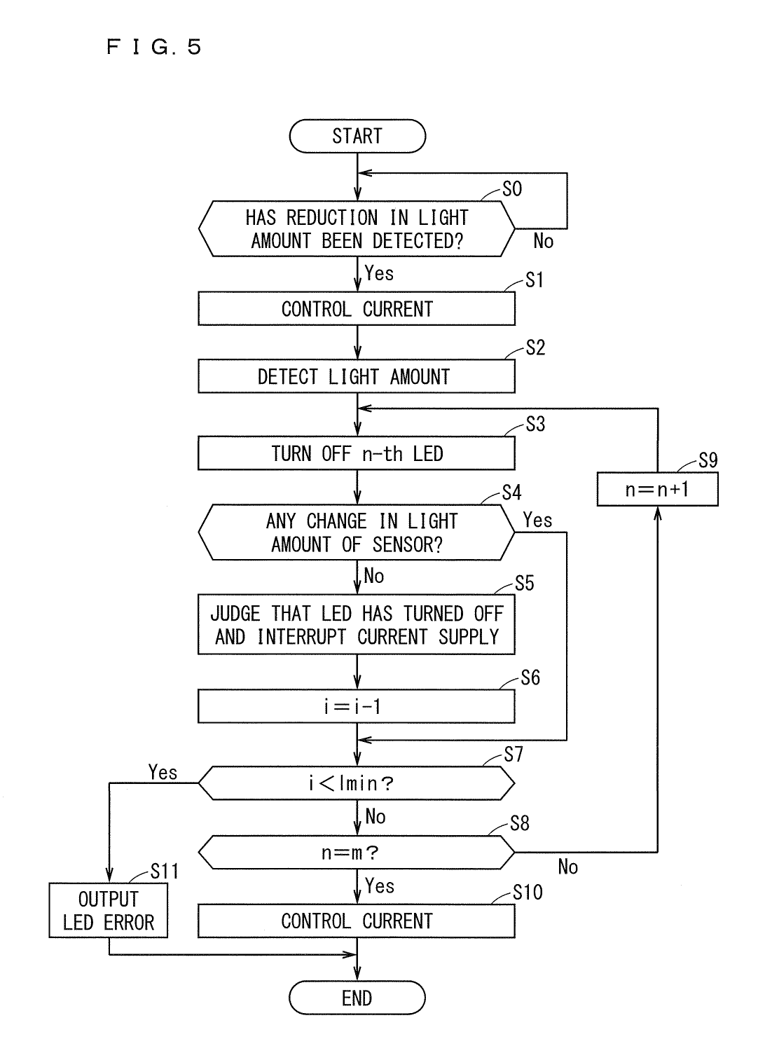

Next, the projection type video display 1 according to a second preferred embodiment is described. FIG. 5 is a flowchart of the operation of detecting an abnormal turning-on of the LED arrays 40R, 40G, and 40B in the projection type video display 1 according to the second preferred embodiment. In the second preferred embodiment, the same components as those described in the first preferred embodiment are denoted by the same references, which are not described here.

The configuration of the projection type video display 1 according to the second preferred embodiment is similar to that of the first preferred embodiment. The operation of detecting an abnormal turning-on in the second preferred embodiment is different from that of the first preferred embodiment in that, upon detection of a reduction in output light amount of the LED array, the turning-off process is performed for the LEDs 50a to 50f forming the LED array in which the reduction in output light amount of the LED array has been detected. The flowchart of FIG. 5 in the second preferred embodiment is obtained by adding Step S0 to the flowchart of FIG. 4 in the first preferred embodiment, and thus, the details described in the first preferred embodiment are not described here.

All the LEDs 50a to 50f normally turn on, and the light amount detection sensor 14 monitors the total output light amount thereof. In a case where, for example, the LED 50a does not turn on due to an open circuit failure, the current applied to the LED 50a is applied to the LEDs 50b to 50f in a distributed manner. However, the total output light amount of the LED array is not identical to the original one based on the relationship between the light emitting efficiency and the current of the LED. In other words, an output light amount detected by the light amount detection sensor 14 reduces. The light source controller 30 detects a reduction in output light amount using the light amount information detected by the light amount detection sensor 14.

In a case where a rated current is applied to the LEDs 50b to 50f, the current increased exceeds the rating. Then, the light source controller 30 judges that an open circuit failure has occurred in any one of the LEDs 50a to 50f when detecting a change in output light amount using the output light amount detected by the light amount detection sensor 14, and controls the current output from the LED drive circuit to reduce by ⅚ times. This reduces an applied current to the LED 50a, and applied currents to the other LEDs 50b to 50f are controlled not to exceed the rated current.

The light source controller 30 starts the operation of detecting an abnormal turning-on and, in a case of detecting a reduction in output light amount of one color (Yes in Step S0) using the light amount information of the light amount detection sensor 14, reduces the applied current If, which is applied to the LED array of the color in which a reduction in output light amount has been detected, by (i−1)/i times (Step S1) so that the currents to be applied to the individual LEDs 50a to 50f are identical to those before the detection operation is started. It is to be noted that the light source controller 30 returns to Step S0 in a case of not detecting a reduction in output light amount (No in Step S0).

Then, the light amount detection sensor 14 detects an output light amount at the current value adjusted in Step S1, and the light source controller 30 stores that value (Step S2). The light source controller 30 controls the current so as to turn off the n-th LED of the target color (Step S3). In other words, the light source controller 30 controls the currents to be applied to the LEDs 50a to 50f to reduce immediately before controlling the currents so as to sequentially turn off the LEDs 50a to 50f. Here, n=1 in the initial state, and thus, the light source controller 30 performs the turning-off process to turn off the first LED.

The light source controller 30 judges the presence/absence of a change in output light amount using the light amount information of the light amount detection sensor 14 (Step S4). More specifically, the light source controller 30 judges (detects) a change in output light amount before and after the LED turns off, to thereby detect an abnormal turning-on of this LED.

In a case of judging that the output light amount has changed before and after turning-off of the LED, that is, when judging that the output light amount after turning-off has reduced than the output light amount before turning-off (Yes in Step S4), the light source controller 30 judges that this LED has turned on before the turning-off process.

Meanwhile, in a case where no change is detected in output light amount, that is, when the output light amount before turning-off and the output light amount after turning-off are the same (No in Step S4), the light source controller 30 judges that the relevant LED has turned off due to, for example, a failure, and then interrupts a current supply to this LED (Step S5). Then, the light source controller 30 executes Steps S6 to S9 and returns to Step S3.

The light source controller 30 repeats Steps S3 to S9 as many as the number of LEDs (m times), and then sets a current value such that If=If0×i/i0 (If0 is a current value before the operation of detecting an abnormal turning-on is started, and i0 is the number of LEDs turning on in start of the operation of detecting an abnormal turning-on) (Step S10).

In other words, an abnormal turning-on of the LED has been detected, and thus, the light source controller 30 controls the current value If to be applied to the LED array to If0×i/i0 such that the current value to be applied to the LED not malfunctioning is identical to the current value before the start of the operation of detecting an abnormal turning-on. A current supply to the malfunctioning LED is interrupted in Step S5. After that, the operation of detecting an abnormal turning-on is ended.

As described above, in the projection type video display 1 according to the second preferred embodiment, when detecting a reduction in output light amount by the light amount detection sensor 14, the light source controller 30 controls currents so as to sequentially turn off a plurality of LEDs 50a to 50f forming the LED array in which a reduction in output light amount has been detected, detects a change in output light amount before and after turning-off of each of the plurality of LEDs by the light amount detection sensor 14 to detect an abnormal turning-on of each LED, and performs control to interrupt a current supply to the LED in which an abnormal turning-on has been detected.

Thus, the turn-on state of a plurality of LEDs 50a to 50f forming the LED arrays 40R, 40G, and 40B can be detected to control turning-on based on the detected turn-on state of the LEDs 50a to 50f. This prevents a situation in which an overcurrent flows into the LEDs 50a to 50f and accordingly the LEDs 50a to 50f are damaged. The use of the light amount detection sensor 14, which is mounted typically for brightness correction, eliminates the need for newly providing a failure detection circuit.

The failure detection circuit becomes unnecessary and the circuit size can be reduced, allowing for miniaturization of the projection type video display 1.

Moreover, one LED is turned off among a plurality of LEDs 50a to 50f forming the LED arrays 40R, 40G, and 40B during the operation of detecting an abnormal turning-on, minimizing a reduction in video brightness during the operation of detecting an abnormal turning-on.

As described in Step S1 of the flowchart of FIG. 5, the light source controller 30 controls currents to be applied to a plurality of LEDs 50a to 50f to reduce immediately before the currents are controlled such that the plurality of LEDs 50a to 50f sequentially turn off. This enables the light source controller 30 to first prevent a failure of an additional LED and then detect the turn-on state of the plurality of LEDs 50a to 50f forming the LED arrays 40R, 40G, and 40B, to thereby control turning-on based on the detected turn-on state of the LEDs 50a to 50f.

While the invention has been shown and described in detail, the foregoing description is in all aspects illustrative and not restrictive. It is therefore understood that numerous modifications and variations can be devised without departing from the scope of the invention.

What is claimed is:

1. A projection type video display that modulates, in response to a video signal, the light emitted from a plurality of light source arrays into video light to project the video light, each of said plurality of light source arrays including a plurality of light sources, said projection type video display comprising:
a controller that performs control on said plurality of light sources, said control including control of currents to be supplied to said plurality of light sources forming said light source arrays, and
a light amount detection sensor that detects an output light amount from each of said light source arrays,
wherein said controller controls the currents so as to sequentially turn off said plurality of light sources forming each of said light source arrays, detects a change in output light amount before and after turning off of each of said plurality of light sources by said light amount detection sensor to detect an abnormal turning-on of each of said light sources, and performs control so as to interrupt a current supply to the light source in which the abnormal turning-on has been detected.

2. A projection type video display that modulates, in response to a video signal, the light emitted from a plurality of light source arrays into video light to project the video light, each of said plurality of light source arrays including a plurality of light sources, said projection type video display comprising:
a controller that performs control on said plurality of light sources, said control including control of currents to be supplied to said plurality of light sources forming said light source arrays, and
a light amount detection sensor that detects an output light amount from each of said light source arrays,
wherein upon detection of a reduction in output light amount by said light amount detection sensor, said controller controls the currents such that said plurality of light sources forming the light source array in which a reduction in output light amount has been detected sequentially turn off, detects a change in output light amount before and after turning off of each of said plurality of light sources by said light amount detection sensor to detect an abnormal turning-on of each of said light sources, and performs control so as to interrupt a current supply to the light source in which an abnormal turning-on has been detected.

3. The projection type video display according to claim 1, wherein said controller performs control so as to reduce the currents to said plurality of light sources immediately before controlling the currents such that said plurality of light sources sequentially turn off.

4. The projection type video display according to claim 2, wherein said controller performs control so as to reduce the currents to said plurality of light sources immediately before controlling the currents such that said plurality of light sources sequentially turn off.
